(19) United States
(12) Patent Application Publication
(10) Pub. No.: US 2011/0122630 A1
(43) Pub. Date: May 26, 2011

(54) Solid State Lamp Having Vapor Chamber

(75) Inventors: Kia Kuang Tan, Penang (MY); Wah Sheng Teoh, Penang (MY); Lay Koon Ong, Penang (MY)

(73) Assignee: DSEM HOLDINGS SDN. BHD., Penang (MY)

(21) Appl. No.: 12/953,370

(22) Filed: Nov. 23, 2010

(30) Foreign Application Priority Data
Nov. 26, 2009 (MY) PI 20095058

(51) Int. Cl. F21V 29/00

(52) U.S. Cl. 362/294

(57) ABSTRACT

A solid state lamp has a form that replaces a standard screw-in or plug-in type light bulb. One or more LEDs are mounted on a thermally conductive submount, which is mounted on the top surface of a substantially round and flat vapor chamber. The vapor chamber efficiently spreads the heat and also conducts heat vertically. The vapor chamber is affixed to a substantially round mounting base of a metal housing. In this way, the very small LED dies appear to the mounting base as much larger heat sources producing less heat per unit area, and the thermal resistance of the heat path is greatly reduced. The housing has ventilation openings for cooling a bottom surface of the mounting base. The top of the vapor chamber is highly reflective, and the housing has a high emissivity coating. A standard base is attached to the housing for connection to an AC mains voltage.

### FIELD OF THE INVENTION

This invention relates to high power light emitting diode (LED) lamps and, in particular, to a heat sinking technique for a high power LED array in a compact form factor, such as an incandescent bulb form factor.

### BACKGROUND

A huge market for light emitting diodes (LEDs) is in replacement lamps for standard, screw-in incandescent light bulbs, commonly referred to as A19 bulbs. The letter “A” refers to the general shape of the bulb, including its base, and the number 19 refers to the maximum diameter of the bulb. Such a form factor is also specified in ANSI C78-20-2003. Therefore, it is desirable to provide an LED lamp that has the same screw-in base as a standard light bulb and approximately the same size diameter or less. Although standard light bulbs have a large surface area to dissipate heat, LEDs are only about 1 mm², so heat removal from high power LEDs is a difficult problem when the LED lamp has to adapt to a preexisting form factor, as further described below. About 80% of the LED power consumption is translated to heat.

Other good markets exist for replacing other standard bulbs with longer lasting and more energy efficient solid state lamps.

For a desirable LED lamp implementation, there are a few basic components: a standard (e.g., E26 or E27) base, an electronic driver (if needed) to convert the mains voltage into the required LED drive voltage, a heat sink, one or more LEDs to generate at least 600 lumens, and secondary optics to create a desired emission pattern, all contained within the A19 form factor or other standard form factor.

The current LED efficacy of 80-120˜lm/W translates to an LED lamp power of 7.5 W. For an Energy Star requirement or a TC-L70 35,000 hrs requirement, the die junction temperature must be maintained preferably below 120° C. The die is typically mounted on a thermally conductive submount, and the temperature at the bottom surface of a typical submount should be kept below 80° C. to keep the die below 120° C. Therefore, with an ambient temperature of 25° C., the delta T design margin for transferring heat from the submount to ambient air is about 55° C. This translates to a system thermal resistance of 55/7.5° C./W, or 7° C./W (assuming a typical LED efficacy), needed to remove sufficient heat from the LED to maintain the junction temperature below 120° C. The cooling requirements for an LED lamp in a standard bulb form factor are actually more demanding, since the heat source is enclosed in a body, resulting in a higher ambient temperature around the heat sink.

A 1000 lumens LED lamp, for replacing a 60 W light bulb or a 1200 lumens compact fluorescent light (CFL), translates to a lamp power of 12 W. The required thermal resistance is decreased to 55/12° C./W, or 4.6° C./W. This means the overall thermal resistance of the vertical stack consisting of the LED, the thermal interface material between the LED and the circuit board, the circuit board, the thermal interface material between the circuit board and the heat sink, and the heat sink (to ambient air) must be below 4.6° C./W. Such a thermal resistance is not practically achievable within an A19 form factor using prior art passive techniques.

Therefore, high power LED lamps greater than about 7.5 W that can directly replace 40 W and 60 W incandescent light bulbs need innovative heat removal techniques to achieve thermal resistances of less than 4° C./W without any active cooling.

What is needed is a new approach to remove adequate heat from a high power LED lamp, using only passive techniques, where the size of the lamp is constrained to, for example, an A19 form factor.

### SUMMARY

In one embodiment, one or more LEDs in an LED lamp are mounted on a thermally conductive submount. The bottom of the submount is metalized. The bottom metal of the submount is diffusion bonded (using heat and pressure) to the top surface of a substantially round vapor chamber. Diffusion bonding avoids the need for an extra thermal interface layer, such as solder.

The vapor chamber efficiently spreads the heat and also conducts heat vertically. The top surface of the vapor chamber (at least surrounding the submount) has a highly reflective layer, such as Ag, for reflecting the LED light. The vapor chamber is affixed to the top surface of a substantially round mounting base that is integral with the round metal housing of the lamp. The metal mounting base has fins on its bottom surface for increasing its bottom surface area. In one embodiment, the housing is cast aluminum. In one embodiment, the metal housing has a form factor for replacing a standard 60 W light bulb. The housing has elongated ventilation openings around its base area for low resistance air flow. By making the contact surface for the vapor chamber integral with the housing, the entire metal housing acts as a large heat sink. The ventilation openings comprise the equivalent of long metal fins around the housing, defining the openings, that have a large surface area cooled by the ambient air. Accordingly, there is no enclosed heat sink. There may also be fins along the inside walls of the housing for increasing the surface area of the housing/heat sink.

To further improve the cooling, the aluminum housing (normally reflective) is coated with a high emissivity (e.g, >0.8) layer for improved dissipation of radiative energy. For example, the aluminum may be anodized (oxidized) and dyed to create a thin black layer over the housing. The anodizing process itself may create a black layer.

A series of air openings surrounding the vapor chamber allow heated air between the vapor chamber and an overlying diffusive cover to pass through the ventilation openings near the screw-in base (or other connector) when the lamp is mounted with the diffusive cover facing downward.

The novel heat sinking design takes advantage of conduction, convection, and radiation as a cooling strategy.

A standard A19 screw-in base, or other standard bulb electrical connector, is attached to the housing for connection to an AC mains voltage when the lamp is screwed into a conventional light bulb socket. The attachment provides a thermal connection for additional heat sinking via a conventional socket. A conventional power converter in the housing converts the mains voltage to the required current for the LED(s).

The thin and flat vapor chamber causes the very small LED dies to appear to the housing's top mounting surface as much larger heat sources producing less heat per unit area. Since the heat from each LED die is spread out over a relatively large area, the thermal resistance of the heat path is greatly reduced, and the entire housing (operating as a heat sink) operates more efficiently to remove heat since there are no hot spots. Therefore, LEDs having a power of greater than 7.5 W can be used in lamps with an A19 form factor.

In one embodiment, the entire thermal path has a thermal resistance of about 4° C./W.

The integrated LED lamp has the following major components: a standard connectivity base (e.g., E26, E27, GU10), an electronic driver (if required depending on the LEDs' voltage drop), a thermally conductive circuit board/submount for electrical connection to the LEDs, an LED array for generating the desired lumens (e.g., up to 1000 lumens), a round and flat vapor chamber for heat spreading, a round and flat metal housing surface on which the vapor chamber is mounted, ventilation openings in the metal housing, and a diffuser or other secondary lens that meets a conventional light bulb form factor. The lamp can be used in any orientation.

The heat sink structure may be used in solid state (semiconductor) lamps or luminaries other than those having an A19 form factor, such as flood light form factors, cylindrical form factors, etc.

### BRIEF DESCRIPTION OF THE DRAWINGS

FIG. 1 is an exploded side view of a portion of an LED lamp in accordance with one embodiment of the invention.

FIG. 2 is a top down view of the vapor chamber, submount, and LED die (or LED array area) in the structure of FIG. 1.

FIG. 3 is an exploded side view of a portion of an LED lamp in accordance with another embodiment of the invention.

FIG. 4 is a cross-sectional view of the completed structure of FIG. 3 showing the reflection of light rays by the surface of the vapor chamber.

FIG. 5 is a perspective top view of the vapor chamber on which is mounted a submount for one or more LEDs.

FIG. 6 is a top down view of FIG. 5.

FIG. 7 is a back view of the vapor chamber of FIG. 5.

FIG. 8 is a cross-sectional view of the vapor chamber, submount, and LED(s) in FIG. 1 or 4 in accordance with an embodiment of the invention.

FIG. 9 is a cross-sectional view of the vapor chamber, submount, and LED(s) in FIG. 1 or 4 in accordance with another embodiment of the invention.

FIG. 10 is a top down view of a submount having mounted thereon a plurality of LED dies connected in series.

FIG. 11 is a cross-sectional view of the submount and LEDs of FIG. 10.

FIG. 12 is an exploded view of a screw-in LED lamp in accordance with an embodiment of the invention.

FIG. 13 is a perspective view of a completed screw-in LED lamp in accordance with an embodiment of the invention.

Elements in the various figures that are the same or similar are labeled with the same element number.

### DETAILED DESCRIPTION

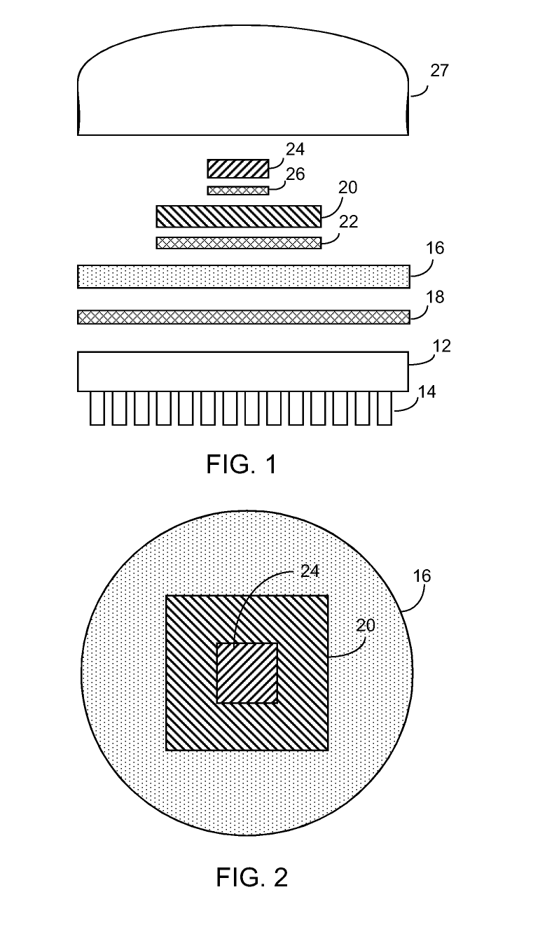

FIG. 1 is an exploded view of a portion of a solid state lamp in accordance with one embodiment of the invention. In one embodiment, the dimensions of the parts are such that they all fit within the form factor of a standard A19 40 W or 60 W light bulb.

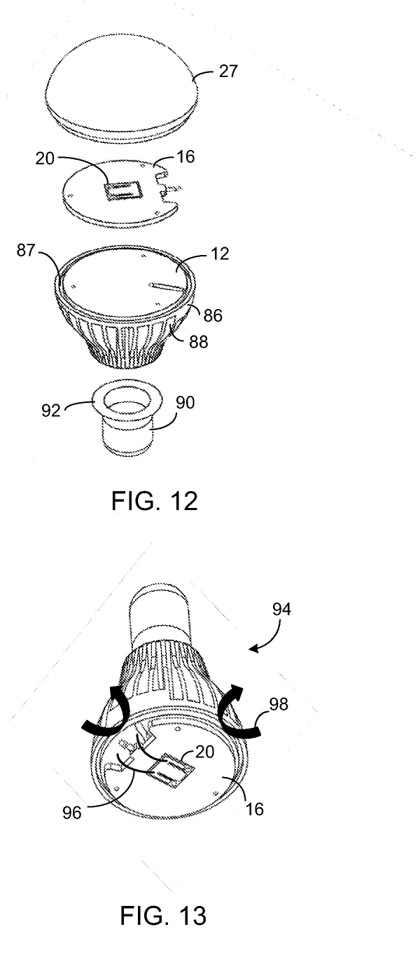

A round aluminum mounting base 12 is an integral part of a cast aluminum housing (shown in FIG. 12). The remainder of the housing is not shown in FIG. 1. The mounting base 12 has integral bottom fins 14 for better air cooling. The fins 14 increase the bottom surface area of the mounting base 12. The aluminum may instead be another high thermal conductivity material. By making the entire housing a single integral metal piece, there is maximum heat transfer throughout the housing.

Affixed to the top of the mounting base 12 is a substantially round vapor chamber 16 for maximum heat spreading. The vapor chamber 16 is typically formed of copper. In one embodiment, the vapor chamber 16 is bolted to the mounting base 12 by bolts extending through flanges around the periphery of the vapor chamber 16. In another embodiment, the vapor chamber 16 is soldered to the mounting base 12. A thermal interface material (TIM) 18 represents, for example, a thin layer of thermal grease that is dispensed between the vapor chamber 16 and the mounting base 12 so that, when the vapor chamber 16 is bolted to the mounting base 12, the thermal grease mostly squishes out but creates uniform thermal contact between the vapor chamber 16 and the mounting base 12. The thermal grease contains high thermal conductivity particles, such as metal particles. The TIM 18 may also be a solder layer, or any other highly thermally conductive material.

The vapor chamber 16 diameter should be wide to spread heat but should not be greater than the diameter of the bulb being replaced. Accordingly, the diameter of the vapor chamber 16 should be no larger than the diameter of the bulb at the largest diameter of the bulb and no smaller than 80% of the diameter of the bulb. Within this range is deemed that the diameter of the vapor chamber is substantially the same as the diameter of the bulb to be replaced.

Mounted on top of the vapor chamber 16 is a submount 20. The submount 20 will typically be formed of a ceramic or aluminum for high thermal conductivity. The bottom surface of the submount 20 is metalized, such as with copper, and soldered or welded to the surface of the vapor chamber 16. The TIM 22 represents the thin solder layer affixing the submount 20 to the vapor chamber 16.

An LED die 24 (representing one or more LEDs) has a metalized bottom surface that is soldered or welded to one or more metal pads on the submount 20 surface. TIM 26 represents a thin solder layer, although the LED die 24 may be ultrasonically welded to the submount pad(s), obviating the need for any TIM 26.

LED dies are extremely thin and brittle. Therefore, the LED manufacturer typically mounts the semiconductor LED die on a more robust submount 20. The fragile electrodes on the LED die 24 are bonded, either directly or by gold wires, to a set of metal contact pads on the submount 20. The LED die 24 and wires (if any) are then typically encapsulated in a lens. The submount 20 has either top pads or bottom metal pads, typically not covered by the encapsulation, that are electrically connected by a metal layer to the LED die electrodes. The exposed submount pads are bonded, such as by wires, to a power source. Such conventional details of the submount 20 are not shown for simplicity.

There may be multiple LED dies 24 mounted on the single submount 20, and/or there may be multiple submounts 20 mounted on the vapor chamber 16.

The submounts 20 described in the examples herein may have a ceramic body (so that its surfaces are insulating) or an aluminum body (called a metal core PCB). For an aluminum core submount, a dielectric layer for supporting metal electrode pads is formed by selective oxidation of the aluminum surface by masking and anodizing. Other types of submounts can also be used.

In another embodiment, for electrically insulated LED dies or other types of suitable solid state emitters, direct mounting of the bottom surface of the dies to the vapor chamber 16 top surface is an option, such as by soldering or ultrasonic welding a bottom metal pad of the dies to the vapor chamber 16 surface. The vapor chamber top surface may be coated (e.g., plated) with silver to create a reflective surface (>95%) that can be easily soldered or welded to.

The vapor chamber 16 is much better for conducting heat away from the submount 20 than a metal board, or even direct bonding of the submount 20 to the heat sink 12. Vapor chambers typically provide greater than 30% more heat spreading than a solid metal plate. Vapor chambers provide both good in-plane and through-plane heat conduction due to the latent heat transfer.

The vapor chamber 16 is a thin closed metal chamber, typically formed of copper, with flat and parallel top and bottom surfaces for even heat spreading. In one embodiment, the vapor chamber is on the order of 3-5 mm thick. The chamber 16 contains a small quantity of a working fluid, such as water, under a partial vacuum. The chamber 16 also contains a wick. The heat source thermally coupled to the top surface of the chamber 16 vaporizes the water in the chamber 16 near the top surface to create a phase change. The vapor is then cooled at the bottom surface by operation of the heat sink 12 and turns into a liquid. This creates a pressure differential that speeds up the movement of the liquid back to the top surface by capillary action through the wick. The flowing of the liquid/vapor inside the vapor chamber 16 helps spreads the heat in two dimensions across the vapor chamber area (in-plane spreading) and also conducts the heat in a vertical direction (through-plane) to the mounting base 12. By spreading the heat over a relatively large area (compared to the size of the LED die), the thermal resistance between the LED(s) and the mounting base 12 is reduced.

The wick inside the vapor chamber 16 may be a copper mesh, sintered metal beads, or other suitable wick for causing the working fluid to move to the heat source side by capillary action. The operation of vapor chambers is described in US Publication Nos. 2006/0196640, 2007/0295486, and 2008/0040925, and U.S. Pat. No. 7,098,486, all incorporated herein by reference.

The vapor chamber 16 is coated with a reflective layer, such as silver, to reflect the LED light.

A diffusive cover 27, such as formed of plastic or glass, is fitted over the body of the lamp to diffuse the light emitted by the substantially point source LED dies. The cover 27 also dissipates radiated heat to the air.

FIG. 2 is a top down view of the substantially round vapor chamber 16, the submount 20, and the LED die 24 (greatly enlarged if a single die). The widest diameter is approximately 2 inches (approximately 5 cm) to meet the A19 form factor of a standard 60 W light bulb. The LED die 24 is about 1 mm² and the submount 20 will typically have sides between 0.5 cm and 2.5 cm. There may be multiple LED dies mounted on the submount 20 surface. The mounting base 12 has a substantially round shape corresponding to the vapor chamber 16.

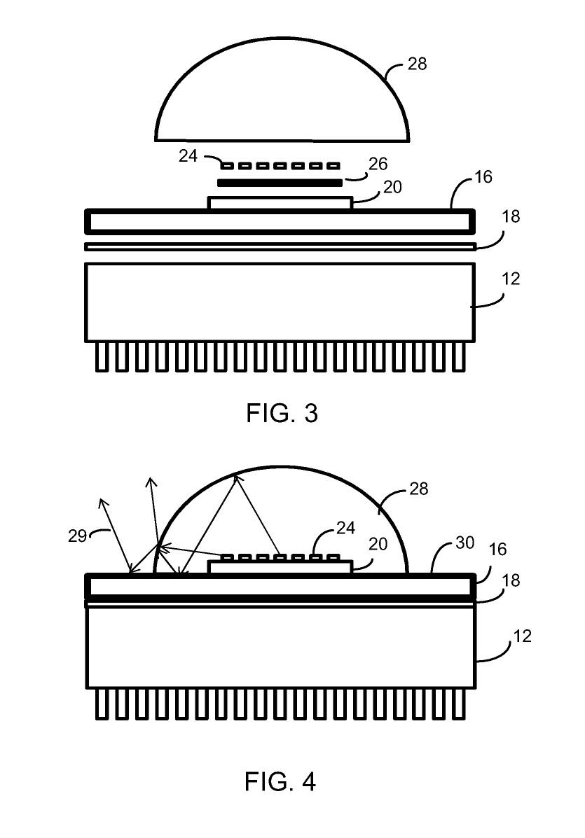

FIG. 3 illustrates another embodiment of a portion of the solid state lamp, where an array of LED dies 24 is mounted on the submount 20 by an optional TIM 26 (e.g., solder). Instead of thermally coupling the submount 20 to the vapor chamber 16 using a TIM, the bottom surface of the submount 20 is coupled to the vapor chamber 16 by diffusion bonding, thereby requiring no interface layer. In the non-electronic field of mechanically connecting two metal pieces together, it is known to use solid state diffusion bonding (SSDB). In SSDB, two metals are pressed together at a temperature below but near the melting points of the metals. Over time, the metal atoms of one piece diffuse into the other piece to create a very strong bond.

According to Kazakov N. F, “Diffusion Bonding of Materials”, Pergamon Press (1985, English version), diffusion bonding of materials in the solid state is a process for making a monolithic joint through the formation of bonds at the atomic level, as a result of closure of the mating surfaces due to the local plastic deformation at elevated temperature which aids interdiffusion at the surface layers of the materials being joined.

In SSDB, there are no joint discontinuities and no porosity in the joint if the mating surfaces are sufficiently polished prior to the SSDB process.

Applicants have discovered that a very low resistance thermal connection can be made between the copper bottom metallization of the submount 20 and the copper top surface of the vapor chamber 16. The mating surfaces must be polished to be very flat. SSDB bonding to an aluminum surface is also an option, although copper is a better thermal conductor.

In one embodiment, at least one metalized submount 20 is provided without the LEDs mounted on the submount 20. The submount 20 is typically custom designed for ultimately having mounted thereon the LEDs using the device manufacturer's standard equipment.

The bottom metallization of the submount 20 and the surface of the vapor chamber 16 are both copper. Since the temperature needed to bond two copper surfaces using SSDB is much greater than the maximum allowable temperature of the vapor chamber 16 containing the working fluid, the working fluid is not introduced into the vapor chamber until the SSDB process is finished.

In one embodiment, the mating surfaces are first mechanically polished. The SSDB process is then performed in a high vacuum at a temperature between 500°-1000° C. (preferably 700°-800° C.), and a pressure of about 500 psi (3.45 MPa) is applied to the opposing surfaces. A lower pressure may be used with a higher temperature.

In another embodiment, the copper metallization on the submount 20 is gold plated. The mating area on the top surface of the vapor chamber 16 is also gold plated. The mating gold layers can be diffusion bonded at a lower temperature than required for copper-to-copper bonding. Any metal-to-metal diffusion bonding is possible with the invention and is not restricted to only copper-to-copper bonding.

Since the SSDB process is performed prior to the LEDs being mounted on the submount 20, there is no damage to the LEDs due to the high temperature and pressure.

The working fluid is then injected into the vapor chamber 16 via a small metal pipe, and the chamber 16 is sealed by crimping the pipe. The bonded vapor chamber 16 and submount 20 is then provided to the LED manufacture for mounting the die(s) to the submount's top metallization pattern.

In another embodiment, the bottom surface of the vapor chamber 16 is diffusion bonded to the mounting base 12 at the same time that the submount 20 is diffusion bonded to the vapor chamber 16.

In another embodiment, the metal circuit traces for the LEDs are printed or laminated on the surface of the vapor chamber 16, obviating a rigid submount 20. The metal traces would be electrically insulated from the vapor chamber 16 by a thin dielectric layer.

Also shown in FIG. 3 is an encapsulating lens 28 (greatly enlarged relative to the diameter of the vapor chamber 16) that encapsulates the LED dies and all or a portion of the submount 20. The encapsulation protects the LED dies and creates a desired light emission pattern.

FIG. 4 illustrates various light rays 29 ultimately reflecting off the highly reflective surface of the vapor chamber 16. There may be LED side light or total internal reflected light off the encapsulant (e.g., silicone) that is reflected upward by the chamber's 16 reflective surface. Additionally, there may be some backscattering of light from the diffusive cover 27 that is reflected by the vapor chamber 16 surface. Providing the vapor chamber 16 with a reflective coating also creates a more uniform light source to better emulate the light emitted from a standard bulb. Silver 30 is preferred as the coating material over the copper vapor chamber 16 body to create a reflectance over 95%. The silver 30 may be deposited by plating, sputtering, an immersion silver process, or other process.

There may be additional optics, such as a collimating lens or a reflective bowl around the LEDs, for beam shaping.

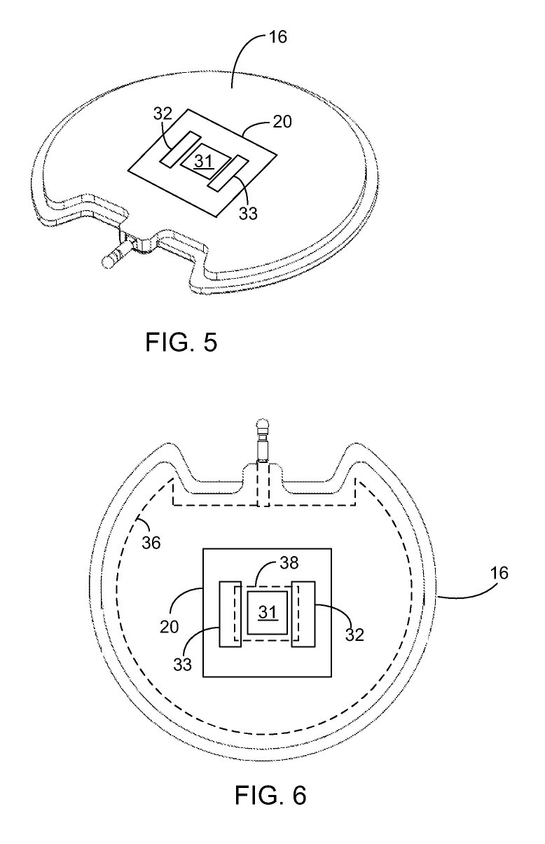

FIG. 5 is a perspective view of the vapor chamber 16 and the submount 20. The metal pads on the submount 20 are shown. There may be a metal bonding pad 31 to which a bottom metallization of the LED die(s) is welded or soldered. There may be metal electrode pads 32 and 33 to which LED die electrodes are electrically connected by direct bonding (for a flip-chip LED) or by gold wires. The metal pattern on the submount 20 may be for mounting multiple LED dies for increased light output and/or to drop a higher voltage.

FIG. 6 is a top down view of FIG. 5 illustrating in dashed outline 36 the boundary of the cavity in the vapor chamber 16. The footprint of the LED die is shown in dashed outline 38 (greatly enlarged for a single die). The footprint shown is for a flip-chip LED, where bottom electrodes of the LED are directly bonded to the pads 32 and 33 without wires. A wire-bonded LED would have at least a top electrode wire-bonded to one of the pads 32 or 33.

In one embodiment, the LED die(s) 24 generates greater than 7 W and produces 600 lumens or more, such as 1000 lumens, equivalent to a 60 W incandescent light bulb.

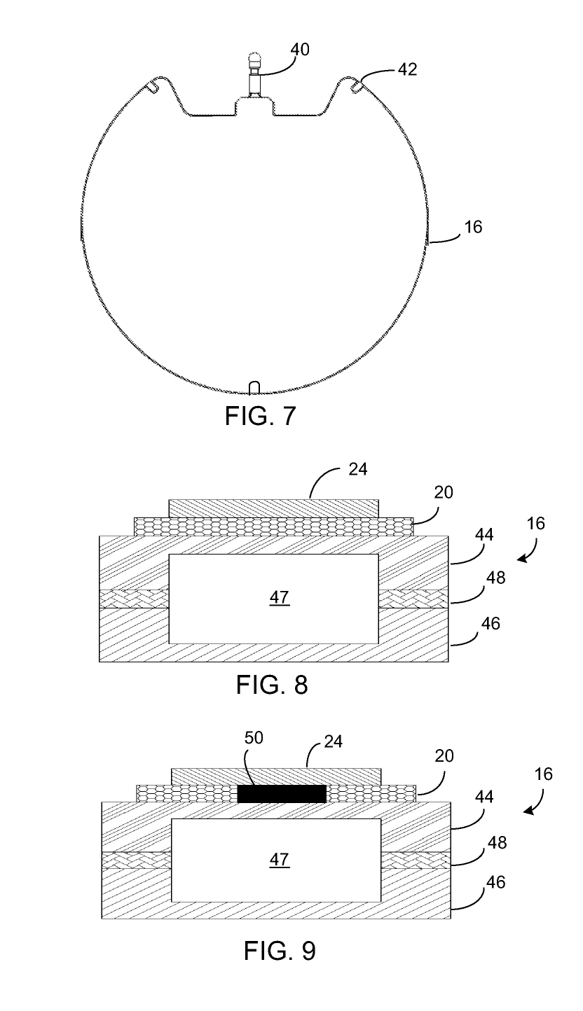

FIG. 7 is a back view of the vapor chamber 16. The working fluid is filled via a metal pipe 40 that is then crimped and optionally cut. Bolt openings 42 are shown in flanges around the vapor chamber 16 for bolting to the mounting base 12.

FIG. 8 is a cross-sectional view of the vapor chamber 16 (laterally compressed), LED die 24, and submount 20. No TIM interface layers are shown. In one embodiment, all bonding is done by diffusion rather than soldering. The vapor chamber 16 is formed of two halves 44 and 46, typically copper, bonded together at an interface 48. In another embodiment, one half is a flat plate and the other half has raised edges for bonding to the opposing surface of the plate. The two halves may be bonded by welding, solder, solid state diffusion, or other process. The wick and liquid are designated as 47.

If the submount 20 has an aluminum core, which is a good thermal conductor, heat from the LED die 24 is conducted vertically through the aluminum core. If the submount 20 is ceramic, at least one copper via 50, shown in FIG. 9, may be formed through the submount 20 and terminate in top and bottom metal pads for good thermal conduction. The top pad is bonded to the bottom metallization of the LED die 24, and the bottom pad is in thermal contact with the vapor chamber 16.

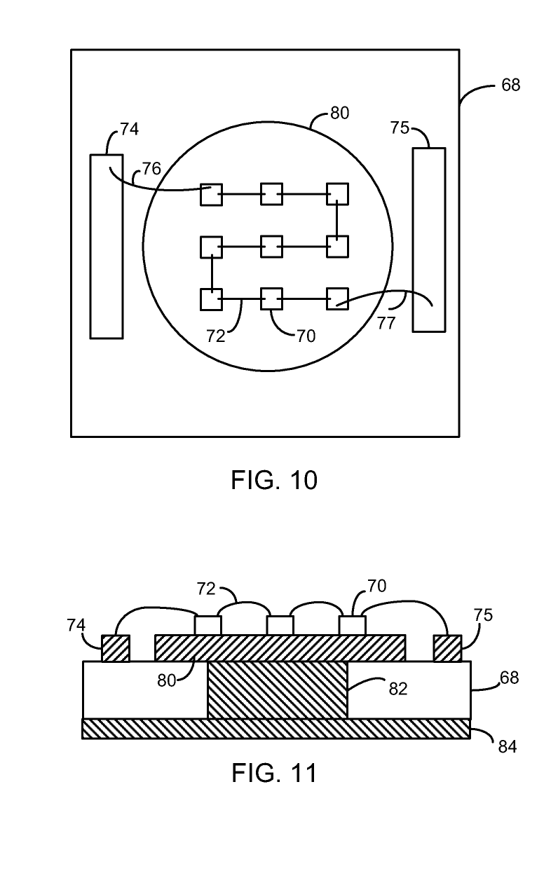

FIG. 10 is a top view of a submount 68 that may replace submount 20 in FIG. 1, where the submount 68 has mounted thereon an array of LED dies 70 connected in series by wires 72. The wires 72 are connected to the metal anode and cathode electrodes on the LED dies 70. The anode and cathode ends of the series string are connected to electrodes 74 and 75 by gold wires 76 and 77. The bottom metallization of the dies 70 is bonded to a common metal pad 80 on the submount 68, or directly to an aluminum body of the submount 68, for thermal conduction through the submount 68.

FIG. 11 is a cross-sectional view of the submount 68 of FIG. 10. If the submount 68 is ceramic, at least one metal via 82 may be formed through the ceramic to improve thermal conductivity. The submount 68 has a bottom metal pad 84 for bonding to the surface of the vapor chamber 16.

FIG. 12 is an exploded view of a solid state lamp having an A19 form factor. The mounting base 12 is a top part of a cast aluminum housing 86 having ventilation openings 88. The housing 86 may be any suitable metal composite, or other thermally conductive material. The housing's inner surface may have thin fins, in addition to the fins 14 in FIG. 1, to increase the surface area exposed to the ambient air. The housing 86 has a groove 87 and openings around the mounting base 12 to allow heated air between the vapor chamber 16 and diffusive cover 27 to escape through the ventilation openings 88 when the lamp is operated with the diffusive cover 27 facing downward.

A screw-in base 90 is substantially identical to that of a standard bulb and connects to a mains voltage supply when screwed into a standard light bulb socket. Such screw-in bases are referred to as E26 or E27 bases. The base 90 may instead be a plug-in base for a standard bulb. The metal of the screw-in base 60 is electrically insulated from the metal housing 86 by a thermally conductive ceramic piece 92 (or other material) that is connected to the housing 86 by bolts, an adhesive, or other attachment means. Electrical leads from the screw-in base 90 are connected to a conventional power converter (not shown) inside the housing 86 that converts the AC mains voltage into the required AC or DC current for powering the one or more LED dies 24. Such power converters are commercially available.

If the lamp is mounted with the diffusive cover 27 facing downward, the ventilation openings 88 allow the air inside the lamp to flow upwards and out the openings 88.

The elongated metal sections that define the ventilation openings 88 act as fins to additionally dissipate heat by providing a large surface area exposed to the cooler ambient air.

FIG. 13 is a perspective view of the lamp 94 with the diffusive cover 27 removed. Wires 96 extend from a power supply to the submount 20 electrode pads to provide current to the LED(s). The wires 96 may be soldered to the submount 20 electrode pads or a connector may be used. The flow of air 98 through the openings 88 removes heat internal to the housing 86. Therefore, the present heat sinking design takes advantage of conduction (direct heat transfer through contact), convection (liquid inside vapor chamber and air flow), and radiation (removal of heat through high emissivity coating of housing) as a cooling strategy.

Although a vapor chamber has been shown as the preferred heat spreader, other suitable heat spreaders may be used as well for lower power light sources or for different form factors.

Although a standard light bulb form factor has been used in the examples, other incandescent and fluorescent bulb form factors may also be used for the solid state lamp. A list of standard bulb and socket form factors can be found at http://www.donsbulbs.com/cgi-bin/r/t.p1/socket.base.html, copyright 2009, incorporated herein by reference.

Having described the invention in detail, those skilled in the art will appreciate that given the present disclosure, modifications may be made to the invention without departing from the spirit and inventive concepts described herein. Therefore, it is not intended that the scope of the invention be limited to the specific embodiments illustrated and described.

What is claimed is:

1. A solid state lamp comprising:
an electrical connector for connection to a power supply, the electrical connector having a form used for a standard light bulb, where the light bulb has a substantially round cross-section and a first diameter at a light emitting area and has its electrical connector at one end;
a substantially round, thermally conductive metal housing, attached to the electrical connector, the housing having ventilation openings and fins, the housing comprising a substantially round mounting base, the housing and mounting base being integrally formed of the same material;
a substantially round vapor chamber, having substantially parallel top and bottom surfaces, the vapor chamber having its bottom surface thermally coupled to a substantially flat top surface of the mounting base, a diameter of the vapor chamber being substantially the same as the diameter of the light bulb, the top surface of the vapor chamber having a reflectance greater than 90%;
at least one solid state light emitting device formed of a semiconductor material being supported by the top surface of the vapor chamber and thermally coupled to the top surface of the vapor chamber, wherein the light emitting device receives power from the power supply via the electrical connector, the light emitting device having a maximum diameter less than half a diameter of the vapor chamber; and
an encapsulating material at least over the light emitting device;
the lamp having a form for replacing the standard light bulb.

2. The lamp of claim 1 wherein the form for replacing the standard light bulb is an A19 form.

3. The lamp of claim 1 wherein the electrical connector is an E26 or E27 connector.

4. The lamp of claim 1 further comprising a semi-transparent cover over the at least one light emitting device and vapor chamber for allowing light to pass through the cover, wherein the housing provides an air opening between the vapor chamber and the housing for allowing heated air between the vapor chamber and cover to be removed from the housing via the ventilation openings,

5. The lamp of claim 1 wherein a body of the housing has a coating with an emissivity greater than 0.8 for radiative heat dissipation.

6. The lamp of claim 1 wherein the at least one solid state light emitting device is mounted on a thermally conductive submount, the submount having a bottom metal surface, the bottom metal surface being diffusion bonded to the top surface of the vapor chamber with no intermediate material in-between.

7. The lamp of claim 1 wherein the at least one solid state light emitting device is mounted on a thermally conductive and electrically insulating circuit layer comprising a metal pattern connected to the light emitting device.

8. The lamp of claim 1 wherein the electrical connector is a screw-in connector.

9. The lamp of claim 1 wherein the electrical connector is a plug-in connector.

10. The lamp of claim 1 where the housing is formed of aluminum.

11. The lamp of claim 10 wherein the aluminum is anodized and a dark color to achieve an emissivity greater than 0.8.

12. The lamp of claim 1 wherein the vapor chamber has a silver top surface layer for reflecting light from the light emitting device.

13. The lamp of claim 1 wherein the at least one light emitting device comprises an array of light emitting diodes.

14. The lamp of claim 1 wherein the electrical connector is electrically insulated from the metal housing.

15. The lamp of claim 1 wherein the vapor chamber is bolted to the mounting base.

16. The lamp of claim 1 wherein the vapor chamber is diffusion bonded to the mounting base.

17. The lamp of claim 1 wherein the vapor chamber has a maximum thickness less than 5 mm.

18. The lamp of claim 1 wherein the at least one light emitting device has a power of at least 7.5 W.

19. The lamp of claim 1 wherein the at least one light emitting device emits light about 600 lumens or greater.

20. The lamp of claim 1 wherein a thermal resistance between the at least one light emitting device and ambient air is less than about 5° C./W.
